(19) United States
(12) Patent Application Publication
(10) Pub. No.: US 2018/0174074 A1
(43) Pub. Date: Jun. 21, 2018

(54) SYSTEM AND METHOD FOR MAKING RESERVATIONS FOR BOTTLE AND VIP SERVICE AT A VENUE

(71) Applicant: JUDE HUDSON, PARADISE VALLEY, AZ (US)

(72) Inventor: JUDE HUDSON, PARADISE VALLEY, AZ (US)

(21) Appl. No.: 15/380,150

(22) Filed: Dec. 15, 2016

(51) Int. Cl. G06Q 10/02; G06Q 30/02; G06F 3/0482

(52) U.S. Cl. CPC G06Q 10/02; G06Q 50/12; G06F 3/0482; G06Q 30/0226

(57) ABSTRACT

A method for reserving a table for bottle service comprising: connecting with a server hosting a reservation platform for table/bottle service reservations and communication; displaying a list of venues having tables for table/bottle service reservations; reserving a table at a venue on the list of venues by an individual through the reservation platform; selecting a reservation type of the table through the reservation platform; selecting a menu for the table selected; sending a confirmation code for the table selected; and scanning the confirmation code by the venue, the confirmation code showing guest name and the table reserved.

### TECHNICAL FIELD

The present application in general relates to a reservation system, and more specifically, to a system and method for making reservations for bottle and VIP service at participating venues wherein participants may book exclusive, semi-exclusive, or reserved group tables.

### BACKGROUND

Bottle/VIP service is an arrangement where the venue may provide the patron with the patron's own private table, booth, skybox or VIP Room. The patron is generally required to purchase or otherwise pay for premium areas, complete bottles of the patron's choice of alcohol, accompanied with mixers, condiments and ice which are served table-side by a personal waitress/waiter. Most venues may set a requirement as to a minimum spending amount required for the table.

The purchase of VIP/bottle service may allow patrons to skip lining up at a crowded bar fighting to try and order drinks. VIP/bottle service may further result in venue cover charges being waived for the purchaser's party and often allows the party to bypass entrance lines.

For a person to reserve VIP/bottle service, the person will generally need to call a venue directly. Because of this, it is difficult to compare prices between several venues. Further, even if patrons are able to reserve VIP/bottle service, the patron may not have any ability to determine who may be seated next to or near the patron's party.

Another way to reserve bottle service may be to use a club host or “promoter” who may work for the venue or may work with the venue as an independent contractor. Many of these hosts and promoters also have websites through which consumers can make reservations for the venues the host or promoter works with, but patrons do not have the opportunity to negotiate for a price or easily compare prices between several venues. Further, the venue host or “promoter” generally only has access to a limited number of venues.

Therefore, it would be desirable to provide a system and method that overcomes the above.

### SUMMARY

In accordance with one embodiment, a method for reserving a table for bottle service is disclosed. The method comprising: connecting with a server hosting a reservation platform for table/bottle service reservations and communication; displaying a list of venues having tables for table/bottle service reservations; reserving a table at a venue on the list of venues by an individual through the reservation platform; selecting a reservation type of the table through the reservation platform; selecting a menu for the table selected; sending a confirmation code for the table selected; and scanning the confirmation code by the venue, the confirmation code showing guest name and the table reserved.

In accordance with one embodiment, a computing device is disclosed. The computing device has a processor; a display coupled to the processor; a user interface coupled to the processor for entering data into the computing device; and a memory coupled to the processor, the memory storing program instructions that when executed by the processor, causes the processor to: connect with a server hosting a reservation platform for table/bottle service reservations and communication; displaying a list of venues having open tables for table/bottle service reservations; reserving a table at a venue on the list of venues by an individual through the reservation platform; selecting a reservation type of the table through the reservation platform; selecting a menu for the table selected; sending a confirmation code for the table selected; and scanning the confirmation code by the venue, the confirmation code showing guest name and open table reserved.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary reservation system according to one aspect of the present application;

FIG. 2 is a simplified block diagram showing an illustrative computer/server device depicted in FIG. 1 in accordance with one aspect of the present application; and

FIG. 3 is an exemplary embodiment of a flowchart depicting a method for reserving table service according to one aspect of the present application.

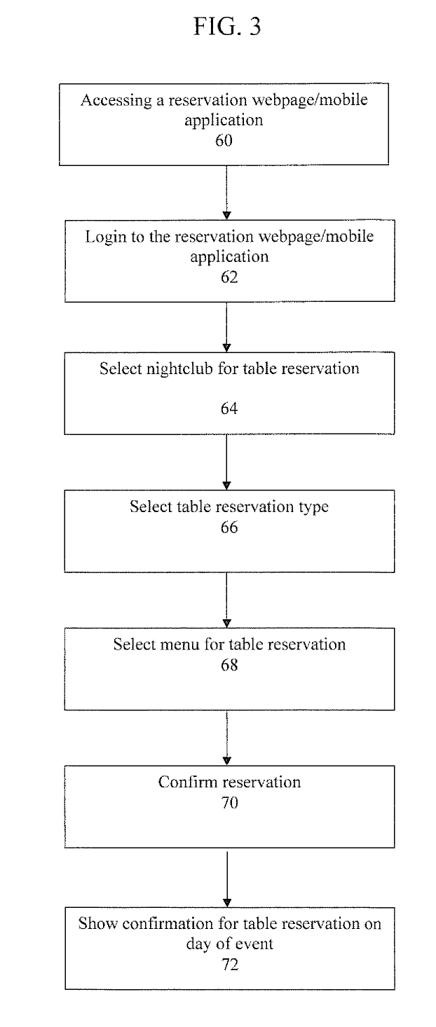

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relates to a system and method for reserving VIP/bottle service at any venue. The system and method may eliminate the need for patrons to call venues and deal with various hosts. The system and method may allow patrons to book VIP/bottle service and be provided with a personal concierge for the night. The system and method may allow patrons to select a table just for the patron and guest, book the whole table and be able to approve or deny other guest requests, provide a table menu along with bottle prices, pre-select the patron's order to achieve minimums, allow users to order additional bottles and/or drinks as a group order or individually, keep an open table or have it closed out before you even arrive so nobody can run up your bill, choose to pre-pay a booking for the patron and guests or secure it with a credit card and pay at the end of the night by yourself or split among your guests. The aforementioned are given as examples of the features of the present application. Other features of the system and method may be disclosed as shown below.

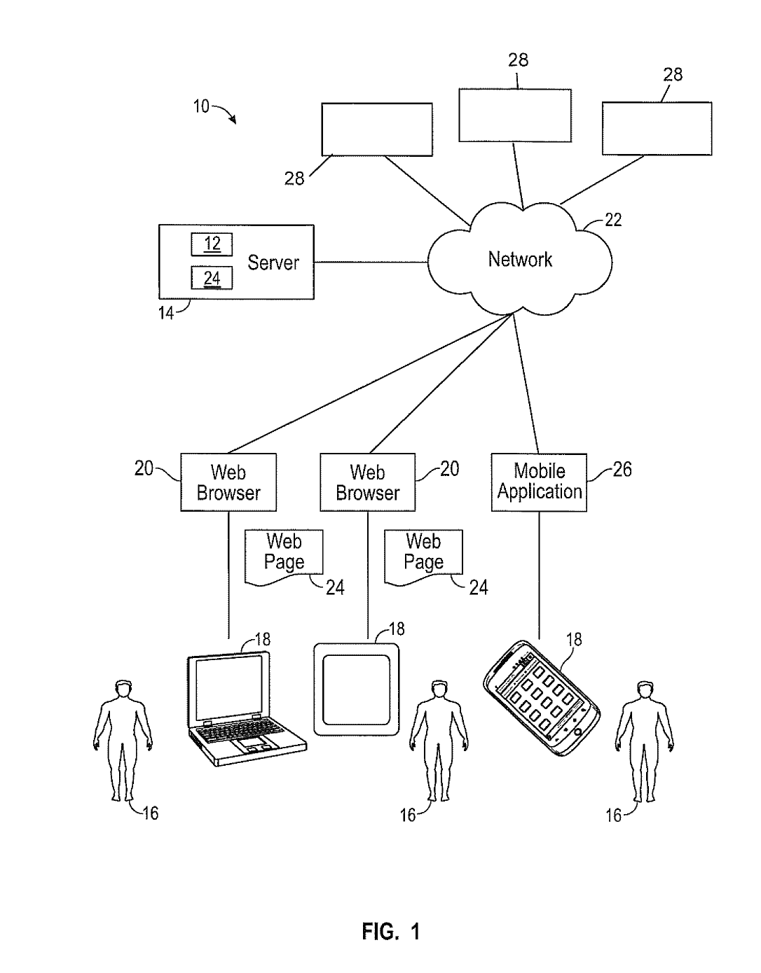

Referring now to FIG. 1, a reservation system 10 (hereinafter system 10) may be shown. The system 10 may provide a reservation platform 12 that may allow for reserving VIP/bottle service at any venue as well as other features as will be disclosed below. The system 10 may have a server 14. The server 14 may be used to host the reservation platform 12 of the present invention. In accordance with one embodiment, the reservation platform 12 may be combined and hosted on an existing reservation system such as OpenTable®, Yelp® Reservation, NexTable® and the like. The above is given as examples of different reservation systems and should not be seen in a limiting manner.

Individuals 16 may use one or more computing devices 18 to access the reservation platform 12 that may be hosted on the server 14. The computing devices 18 may be a personal computer system, tablet device, handheld or laptop device, mobile phone device, server computer system, multiprocessor system, microprocessor-based system, set top boxes, programmable consumer electronics, network PCs, and distributed cloud computing environments that include any of the above systems or devices, and the like. The computing device 18 may be described in the general context of computer system executable instructions, such as program modules, being executed by a computer system as may be described below.

The computing device 18 may be loaded with an operating system. The operating system of the computing device 18 may manage hardware and software resources of the computing device 18 and provide common services for computer programs running on the computing device 18. The computing device 18 may be loaded with a web browser 20. The web browser 20 may allow the computing device 18 to gain online access to a network 22 such as the World Wide Web. The web browser 20 may be Microsoft® Internet Explorer, Google® Chrome, Mozilla® Firefox, Apple® Safari or similar browsing applications. By connecting to the network 22, the computing device 18 may access a website 24 associated with the reservation platform 12 hosted on the server 14.

Alternatively, or in addition to, the computing device 18 may download a mobile application 26. The mobile application 26 may access and communicate with the reservation platform 12 hosted on the server 14. By connecting to the network 22, the computing device 18 may access and communicate with the social platform 12 hosted on the server 14 via the mobile application 26.

A plurality of venues 28 may access the reservation platform 12 that may be hosted on the server 14. The venues 28 may access the server 14 to review and confirm reservations as well as to update information on and/or about the venue 28. For example, the venue 28 may update information about specials the venue 28 may be having. The venue 28 may access the server 14 through computing devices 18. By connecting to the network 22, the computing device 18 may access and communicate with the social platform 12 hosted on the server 14.

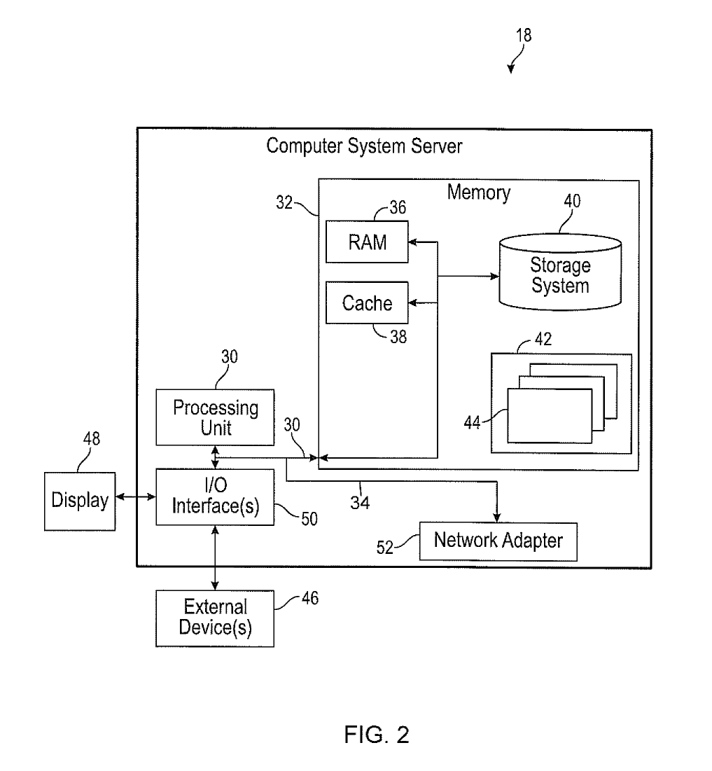

Referring now to FIG. 2, the server 14 and the computing devices 18 may be described in more detail in terms of the machine elements that provide functionality to the systems and methods disclosed herein. The components of the server 14 and computing devices 18 may include, but are not limited to, one or more processors or processing units 30, a system memory 32, and a system bus 34 that couples various system components including the system memory 32 to the processor 30. The server 14 and computing devices 18 may typically include a variety of computer system readable media. Such media could be chosen from any available media that is accessible by the server 14 and computing devices 18, including non-transitory, volatile and non-volatile media, removable and non-removable media. The system memory 32 could include one or more computer system readable media in the form of volatile memory, such as a random access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein. For example, the program modules 44 may carry out the steps for initiating and reserving VIP/bottle service at a specific venue and other functionality as will be described below.

The server 14 and computing device 18 may communicate with one or more external devices 46 such as a keyboard, a pointing device, a display 48, and/or any similar devices (e.g., network card, modern, etc.) that enable the computing device 18 to communicate with the server 14 (FIG. 1). Such communication may occur via Input/Output (I/O) interfaces 50. Alternatively, the computing devices 18 may communicate with one or more networks such as a local area network (LAN), a general wide area network (WAN), and/or a public network (e.g., the network 24 shown in FIG. 1) via a network adapter 52. As depicted, the network adapter 52 may communicate with the other components of the computing device 18 via the bus 36.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Referring to the FIGs, one embodiment of operation of the reservation platform 12 may be described. To access the reservation platform 12, individuals 16 may access the webpage 24 or download the mobile application 26 via a computing device 18 of the individual 16. The mobile application 26 may be downloaded from iTunes®, Google Play®, Apotide® or other similar mobile application download sites. Once the individual 16 accesses the webpage 24 or opens the mobile application 26 as shown in 60, the individual 16 may review and search different venues 28. While reviewing and searching different venues 28 may be done by any individual 16 of the system 10, in accordance with one embodiment, individuals 16 may need to register/login in order to reserve VIP/bottle service at a particular venue 28 as shown in 62.

The webpage 24 or the mobile application 26 may have a registration/login link/tab. By selecting the registration/login link/tab using an external device 46 (i.e. keyboard, mouse, etc) of the computing device 18 of the individual 16, the individual 16 may be taken to a login screen. The login screen may have a User ID area and a password area. Once the individual 16 enters the corresponding user information in the User ID area and the password area, the individual 16 may press a login button using an external device 46 (i.e. keyboard, mouse, etc) of the computing device 18 of the individual 16. The user information may be sent to the server 14 hosting the reservation platform 12 for verification. If the user information of the individual 16 is verified, the individual 16 may be able to reserve VIP/bottle service at any venue 28 using the system 10.

In accordance with one embodiment, the login screen may have an area to allow the individual 16 to remain logged in to the system 10. By selecting this area using an external device 46 of the computing device 18, the individual 16 may remained logged in to the reservation platform 12. In this manner, the individual 16 may not have to go through the login screen.

If the individual 16 is new to the reservation platform 12, the login screen may have a link for the individual 16 to register and become a member of the reservation platform 12. By selecting the link using an external device 46 of the computing device 18 of the individual 16, the individual 16 may be sent to a registration page. The registration page may have a User ID area for entering a User name of the individual 16. In accordance with one embodiment the User ID may be an email address of the individual 16. However, other User IDs may be used without departing from the spirit and scope of the present invention. A confirmation area may be provided on the registration page for the individual to confirm that the User name. In accordance with one embodiment, additional information may need to be submitted on the registration page. For example, an age verification area may be provided to allow one to confirm that the individual 16 is above a certain age. A cellular phone area may be provided to provide an additional level of security. A verification code area may be provided to help prevent disruptive use of auto-fill programs. Additional user information areas may be provided to allow the individual 16 to provide additional user information such as a user's actual name, date of birth, sex, type of music the individual 16 prefers, personality type (i.e., life of the party, goes with the flow, keeps to themselves), credit card number and billing address, digital payment authorization form with ID, as well as other similar information. The above is given as examples and should not be seen in a limiting manner.

Once the individual 16 has entered the information in the User ID area and the confirmation area, the individual 16 may press a submit button via an external device 46 of the computing device 18 of the individual 16. The User ID information may be sent to the server 14 to verify if the user ID is available. If the User ID is available, the server 14 may send a notification. The notification may ask if the individual 16 would like to receive alerts sent by the server 14. The alerts received on the computing device 18 of the individual 16 may be set in the “Settings” page of the computing device 18 of the individual 16. The alerts may be regarding the account of the individual 16, specials offered by the venue 28 and the like.

The individual 16 may register in other ways. For example, the individual 16 may register using other accounts and/or social media links. For example, the individual 16 may register by linking a Google® Account, Facebook® account, Instagram® account and the like. The above are given as examples and should not be seen in a limiting manner.

After registering and being approved, the individual 16 may be sent to a personalized profile page. The personalized profile page may have a personal information area. The personal information area may allow the individual 16 to set/edit the personal information disclosed above about the individual 16. Individuals 16 may be able to set-up alerts to be notified when specific venues/cities have table openings that fit their needs, special events and the like. Notifications may be sent by the server 14 to the individual 16 via Short Message Service (SMS), text messaging, email, or the like. The above is given as notification examples and should not be seen in a limiting manner.

When a venue 28 accesses the reservation platform 12, the venue 28 may access the login screen. The login screen may have a venue link/tab. Using an external device 46 of the computing device 18 of the venue 28 may select the venue link/tab and be sent to a venue login/registration page. The venue login/registration page may allow the venue 28 to establish a link to the venue's website or allow the venue 28 to set-up a venue page on the server 14. The venue's website or the venue page on the server 14 may allow the venue 28 to show a layout of the venue, VIP areas, bottle service information, pictures/video from inside the venue 28, schedule and special events, special offers, contact information and the like. The above is given as examples and should not be seen in a limiting manner. The venue may edit the venue's website or the venue page on the server 14 to include any information.

The venue login/registration page may have a venue ID area for entering a User name of the venue 28 and a password area to enter the venue password. Once the individual 16 has entered the information in the venue ID area and venue password area, the venue 28 may press a submit button via an external device 46 of the computing device 18 of the venue 28. The venue ID information and venue password may be sent to the server 14 for verification. Once verified, the venue 28 may be sent to the venue page on the server 14 where the venue 28 may make edits to the venue page. Information on the venue page may include, but is not limited to: information about the venue 28 (i.e., type), location and contact information, dress code specifications and several image examples of what's allowed and what's not, pictures of the venue 28, pictures of each table and seating/standing capacity of the table, food and beverage menu, menu of available options and upsells, venue rating and reviews, staff and the like. The above is given as an example and should not be seen in a limiting manner.

When the individual 16 logins to the reservation platform 12 via the website 24 and/or mobile application 26, the individual may reserve service at any participating venue 28 as shown in 64. The participating venue 28 may be presented to the individual 16 in a plurality of manners. Based on where the individual 16 list as a resident city, the server 14 may list venues alphabetically in the resident city. Alternatively, venues 28 may be listed based on ratings provided by individuals 16 using the system 10 or have a name search block where the individual 16 may enter a name of a venue using an external device 46 of the computing device 18.

The website 24 and/or mobile application 26 may have links/tab to present the venues 28 in the following manner: (1) Near Venue Button/LiveMap—listing all venues 28 around the individual's resident (i.e., either on a map or list where the closest venues 28 may be listed first); (2) Geo based on the users location, showing venues 28 within 1/5/10/25/50 mile radius options; or (3) Choice of countries and cities of participating venues. From there the user will select: (1) All venues 28 in the area or (2) Only venues 28 with available tables and/or Booking Type: Exclusive; Semi-Exclusive; Reserved Group or Open Group as will be discussed below.

When the individual 16 clicks on one of the venues 28 listed, the individual may be taken to the profile page of the venue 28 on the server 14. As stated above, the profile page may provide the individual 16 with venue information, images from the venue, a 3-Dimensional view of the venue 28, table service menu as well as other information. Special events being held at the venue 28 may also be shown such as a big DJ or celebrity host may also be shown. The above is given as an example and should not be seen in a limiting manner.

When the individual 16 decides to book bottle service at a participating venue 28, the individual 16 may select a reservation tab on the venue page. The reservation tab may show a layout of the venue 28 and tables that are available to reserve. Once a table is selected, the individual 16 may select a reservation type as shown in 66. In accordance with one embodiment, the individual may be presented with four (4) options for booking the table. The first is an Exclusive Table Booking. In the Exclusive Table Booking, the individual 16 books the whole table exclusively for the individual 16 and his/her guests.

The second booking option is a Semi-Exclusive Table Booking. In a Semi-Exclusive Table Booking, the individual 16 books and commit to paying for the entire table and the individual 16 reserves the right to accept or deny other guests. The table may appear in the public booking section as an available semi-exclusive table with an approval process. Other individuals 16 using the system 10 can request to purchase a place at the table. As other individuals 16 apply to join the table and the individual 16 reserving the table approves them, the responsibility of the individual 16 who reserved the table for paying for the entire table may be reduced proportionately to the number of guests at the table as the tab may now be equally split between the parties. For example, a table may have room for 10 guests. The individual 16 may book the table as a semi-exclusive table booking for the individual and 4 guests. The individual 16 agrees to pay for the entire table. The table may appear in the public booking section as an available semi-exclusive table with an approval process for 5 more seats. The individual 16 may accept or deny any request for the 5 open seats. If another individual 16 books the table for himself and 4 guests, the individual 16 who originally booked the table may accept or deny the request. If the request is accepted, the tab may now be equally split between the parties. However, if the request is denied, the individual 16 who originally booked the table is still responsible for the tab of the entire table.

The third booking option is a Reserved Group Table Booking. In this option, the venue 28 provides their minimum booking commitment prices per table. The individual 16 who books the table commits to paying for the table minimum regardless of if or how many other individuals 16 book at the same table. As more individuals 16 book places at the table, the price drops proportionally and everyone pays an equal amount.

The fourth booking option is an Open Group Table Booking. In an Open Group Table Booking, the venue 28 provides their minimum booking commitment numbers. An individual 28 may request his/her place(s) at the table. A fully refundable deposit will be taken from the individual 16. If the table doesn't get confirmed (i.e., the minimum number of spots is not reserved), then the full deposit will be refunded. In general, the refundable deposit may be a funds hold placed on a credit card of the individual 16. Once the minimum number of individuals 16 has requested places at the table, the reservation will be confirmed and the individuals 16 who reserved spots at the table may be notified.

Once the individual 16 has selected their table booking type, the individual 16 may be able to select if they would like for it to be a themed table. A menu of available themes may be provided on the venue page. For example, the individual 16 may select from the following themed table types, including but not limited to: Gender (All females/males), Age or age range, couples only, singles only, minimum customer rating, guest type (Life of the Party, Goes with the flow, Keeps to themselves as indicated when the individual 16 registers with the system 10), ethnicity (i.e. Asian night, Ex-pats, etc.), event (i.e., birthday, bridal party, divorce party, engagement party, etc.). The above is given as examples and should not be seen in a limiting manner. The venue 28 may charge a small premium for a themed table i.e. a 2% additional charge+a standard $50 cost.

After selecting the table type and choosing an optional themed table the individual 16 may be presented with an alcohol menu to select the initial alcohol for the night to meet the initial table minimums as shown in 68. If the table is an exclusive or semi-exclusive then the individual 16 reserving the table may select 100% of the alcohol for the table minimum. If the table is a reserved group or open group table, individuals 16 reserving the table will have to vote for the alcohol selection. Each seat at the table may receive a vote for how the alcohol will be selected. Each individual 16 may simply choose from the menu and suggest how they wish to achieve the table minimum. As other individuals 16 reserve seats at the table, they will also cast votes to decide the alcohol selection, based on everyone's combined vote; a system algorithm may select the most desired alcohol selection for the table.

Once the alcohol has been selected, the individual 16 may submit the reservation request to the server 14 using an external device 46 of the computing device 18 of the individual 16 for confirmation. Once the server 14 confirms the reservation, the individual 16 may be provided with a concierge contact for their booking. In accordance with one embodiment, the concierge contact may be an employee of the system 10 who will be their liaison if they run into any troubles or need any assistance.

During the booking process, the individual 16 may request certain additional services. These additional services may be based on if the venue provides the requested services. For example, additional services that may be requested may include, but is not limited to: private security guard for the table for the night, guaranteed waitress service levels for table attentiveness, photographer by the hour or for the night, celebrity host/guest, atmosphere models, personal mixologist, or other available special requests. The above is given as examples and should not be seen in a limiting manner.

When the reservation is confirmed by the server 14, the server 14 may send the individual 16 a confirmation as shown in 70. The confirmation may be sent an email, text or other communication means. In accordance with one embodiment, the confirmation may be a barcode, QR code or similar means. The above are given as examples and should not be seen in a limiting manner. On the day of the reservation, the individual 16 may simply show the venue table host the confirmation as shown in 72. The venue table host may scans the confirmation code for the details of the reservation (Primary guest, number of additional guests, table location, purchase price, bottle selection, purchase history and rating of the individual, etc.).

The system 10 may be configured such that once a reservation has been made, the individual 16 may select a status update link using an external device 46 of the computing device 18 of the individual 16. The status update link may add the reservation to the individual's calendar schedule, update their Facebook or send a tweet. The above are given as examples and should not be seen in a limiting manner.

After a reservation, has been confirmed, the reservation may be cancelled. During the reservation process the individual 16 may select whether they wish to book the reservation as a refundable or non-refundable reservation. Refundable reservations may be priced at a higher rate. For example, refundable reservations may have a bookings cost of 25% more than a non-refundable reservation. Reservations may also come with a tiered cancellation fee. For example, if the reservation is cancelled:
Less than 24 hours notice=25% cancelation fee
24-48 hours notice=10% cancelation fee
48+ hours=no cancellation fee
   Refunds may be credited back to the individual's credit card on record. In accordance with one embodiment, refunds may be issued as site credits. In the rare event of a cash refund, the cash refund may incur a processing fee and be issued via a check.

Once the table has been reserved, the individual 16 may have the option to invite guests to the table. The individual 16 may select to invite guests for free or to share the cost of the table. The individual 16 may send invites using a contact list on the individual's computing device 18. An invite page may auto-populate information about the reservation onto an invitation form. Alternatively, the individual 16 may fill-in information about the reservation on an invitation from. The individual 16 may send invites by entering a phone number or email address (i.e., sending the invite by email/text/etc.) Alternatively, the individual 16 may post the event on a social media site and provide the ability to share open seats via bit link twitter integration (opens app or sends you to the app store). As individuals 16 reserve tables and mingle with other users, they will have access to send both free and paid invites to their history of guests. At the end of the booking process, the individual 16 may also select to “Do not share my attendance record publicly”. Doing this simple eliminates that individual's username from being listed on other user's histories that were also at the table. It will simply say VIPr guest.

Once the individual 16 has completed the booking of an exclusive, semi-exclusive, or reserved group table or as soon an open group table is confirmed the booking will show up in the active bookings section of the individual's profile page. From the active bookings section the individual 16 may do the following: (1) store a scan-able code booking confirmation along with a detailed email booking confirmation, (2) message the other guests at the table, (3) contact their assigned concierge for support; and (4) be provided with their venue table host name to ask for at the venue along with their waitress/waiter's name 24 hours before the event date. The above is given as an example and should not be seen in a limiting manner.

On the day of the reservation, when the individual 16 approaches the venue, the individual 16 may present the confirmation code for the venue to scan. The venue table host may scan the confirmation code for the details of the reservation (Primary guest, number of additional guests, table location, purchase price, bottle selection, purchase history and rating of the individual, etc.). The above is given as an example and should not be seen in a limiting manner.

During the evening, the individual 16 may use the mobile application 26 for a variety of purposes. As previously stated, the mobile application 26 may have a layout of the venue 28. Thus, one may use the mobile application 26 throughout the evening to locate the restrooms, entrance/exit, coat check, etc. Using the location service on the mobile computing device 18, directional arrows may guide the individual 16 around the venue 28 as well as to find the venue table host. The mobile application 26 may be used to send request to different personnel at the venue 28. For example, the mobile application 26 may be used to send request to the venue 28 for a security guard, venue table host, waitress, manager or other personnel.

The mobile application 26 may be used to communicate between the individual 16 and invited guest. The individual 16 may send direct messages, text, emails or the like to all of the invited guest or select specific guests to receive these messages. In a settings page on the profile page of the individual 16, each individual may be able to select if they wish to have these texts and emails forwarded to their personal phone number/email address or remain in the mobile application 26.

The individual 16 may use this functionality to nominate guests of honor who don't have to pay (birthday, bride, etc.). This communication feature may be used to allow the individual 16 to communicate with the concierges, venue table host, or other individuals associated with the venue 28.

As the individual 16 continues to use the system 10, they may add new party contacts to the individual's network. The individual 16 may refer friends of friends who have similar rating feedback values, to enable one to grow their social network.

The mobile application 26 may be used for at table purchasing and customer service. Additional food and alcohol orders may be made directly at the table from the mobile application 26. The individual 16 and invited guest may have the venue's full available menu provided to them via the mobile application 26. They can make an order directly via the mobile application 26 and it may be sent to the tables without the need to wait for the waitress. This may reduce down time between reorders, thereby increasing overall table spending.

If the table is booked as an Exclusive Table, then only the individual 16 who booked the table may order additional orders for the table. Individual guests may choose to order for themselves individually and be solely responsible for the bill of their additional order(s) via their own personal account.

For all other tables, additional orders can be made individually or split by the table. If splitting by the table, the order will be proposed to all the paying guests, those who wish to share in the next order may participate and share, those who don't wish to order, will simply be excluded from the additional order.

In addition to purchasing, individual 16 may request to see their venue table host or the waitress for any reason they may need them for.

The mobile application 26 may be used to request additional venue services if provided by the venue. These services as disclosed above may include, but is not limited to: private security guard for the table for the night, guaranteed waitress service levels for table attentiveness, photographer by the hour or for the night, celebrity host/guest, atmosphere models, personal mixologist and the like. As disclosed above, the listing is given as an example and should not be seen in a limiting manner. Due to the limited personnel, some of these requests may need to be made during the booking process and may not be available upon request.

The mobile application 26 may allow individuals 16 to save their pictures from the night to their cloud photo album. Photo albums for the night may be shared with all table guests or kept private to the individual 16. Even from private albums, photos can be easily shared with other individuals 16 if the owner of the photo wishes. Individuals 16 may also post photos from the night to the venue page. However, the venue may remove any photos the venue deems to be inappropriate. The venue may at all times have control as to content posted on their venue page hosted on the server 14. The mobile application 26 may provide special filters for users to take pictures/videos.

Every time an individual 16 makes a reservation, the reservation may be saved within their booking history section on the profile page of the individual 16. The booking history will provide the user with the following information: (1) date and time of the event, (2) venue location, (3) itemized breakdown of the bill, (4) name of the waitress that night, (5) name of the venue table host that night, (6) name of the concierge that night, (7) list of guest (by username), these guests may be messaged or invited to future events, (8) as well as other information regarding the evening.

The website 24 and/or mobile application 26 may provide a rating system. As individuals 16 interact with other users of the system 10, individuals 16 can rate them and users may rate the individual 16. In accordance with one embodiment, ratings may be based on a scale of 1-5 stars, 1 star being the poorest of ratings and 5 stars being the best. All ratings for each individual 16 may be combined and averaged. In general, there will not be a comments section to prevent bullying of individuals 16. However, in accordance with one embodiment, a comment section may be provided. However, if a comment section is provided, the comment section may be designed wherein individuals 16 may remove or protest to the owners of the system 10 to have removed any overly negative comments.

Individuals 16 can also rate the venue 28 they attend with both a star rating of 1-5 in addition with a more detailed comments section similar to other restaurant review systems like Yelp®, Zagat®, and the like. These reviews will allow individuals 16 to write reviews of the venue, the staff, and the experience as a whole. All of the reviews will be available to individuals 16 using the system 10. The reviews will be posted on the venue page hosted on the server 14.

The website 24 and/or mobile application 26 may provide a music section. The music section may allow users of the system 10 to go back and listen to the DJ sets from the venues the individual 16 has attended where participating DJ's/Venues have uploaded their sets.

The system 10 may be configured to have a reward program. Thus, the more the individual 16 spends at participating venues on the system 10, the more points the individual 16 may earn. Points earned may be used for future table bookings, in venue purchases, upgrades and for special points only offers like meet and greets, etc. The above is given as examples and should not be seen in a limiting manner.

Once an individual 16 sets up an account, the individual 16 may receive a certain number of points for every dollar spent. In accordance with one embodiment, the individual 16 may receive bonus points after spending a certain amount of money. For example, the individual 16 may receive 100,000 Bonus Points after he/she spends their first $500 within 90 days of opening his/her account.

As stated above, points may be used for in club purchases. For example, 100,000 points may equal $100 in-app currency purchasing ability. In accordance with one embodiment, points may be accumulated indefinitely and may not expire as long as the individual 16 makes a minimum number of reservations per year.

In accordance with one embodiment, the rewards program may be a tiered system. Thus, as the individual 16 spends more money via table bookings, they will achieve new status levels. Each status level rewards the individual 16 with more points per dollar spent, the user will receive more exclusive special offers and be provided with better tables deals as they become available. For example:

| Silver Level: | $0 to $10,000 | $1 spent = 10 Points |
|---|---|---|
| Gold Level: | $10,001 to $25,000 | $1 spent = 15 Points |
| Platinum Level: | $25,001 to $100,000 | $1 spent = 20 Points |
| Elite Level: | $100,001+ | $1 spent = 25 Points |

In accordance with one embodiment, the rewards program may offer certain specials. For example, double points may be offered at certain venues. However, to cover the fees associated with double points, the venue may have to pay the owners of the system 10 an advertising fee to be able to offer double the points for use at other venues.

In accordance with one embodiment, the rewards system may be designed to offer specials which may only be redeemable through the use of the points.

In accordance with another embodiment, the individual 16 may be given bonus points for referring new individuals 16 to sign up to use the system 10. For example, for each new user the individual 16 refers, the individual 16 may receive 5,000 loyalty rewards points.

The system 10 may be configured to have a leaderboard based on the loyalty rewards points. All users may automatically be entered into the leaderboard. However, users may choose to have their account remain anonymous from the leaderboard. In accordance with one embodiment, different leaderboards may be provided. For example, the system 10 may provide an overall leaderboard, leaderboards based on city, state/province, country, leaderboards per venue, and the like. The above are given as examples and should not be seen in a limiting manner. The purpose of the leaderboard will be to reiterate large scale spending for the average user, and provide for a contest mechanism that promotes heavy spending.

Inappropriate behavior may cause the individual 16 to be banned from using the system 10. Things to possible temporarily or permanently ban members of the system may be, but not limited to: being caught with/using drugs in the venue, fighting in or around the venue, theft, rude obnoxious behavior to fellow individuals 16, any type of criminal activity in or around the club. The above is given as an example and should not be seen in a limiting manner. Venues may report and record this information within the system 10. Such behavior may affect the rating of the individual 16 exhibiting such behavior.

The system 10 may allow venues to view reservation information and history. Every time a table is reserved, it may be saved within the venue's table booking history section. The table booking history will provide the venue with the following information: date and time of the booking, total spent, if the table was booked via the system 10, venue or other, if the booking was referred by anyone, itemized breakdown of the entire bill, name of the waitress that night, name of the venue table host that night, name of the primary guest(s), list of the other guests (by username and spending achievement level), these guests may be messaged or invited to future events and the like. The above listing is given as an example and should not be seen in a limiting manner.

The venue may review the table history to see all individuals who have reserved tables and been at the venue. Venues can search by name, date, event, spending rage, membership level for targeted marketing.

The venue may use the system 10 for staffing. Upon logging into a staff section of the venue page, venue staff may see where they will be assigned. For example, the venue table host(s) and waitresses may see which tables they are assigned to for the evening. For the tabled assigned to the venue staff, the venue staff may be proved with: primary guest name(s), number of guests, estimated time of arrival, alcohol selection, open or closed table tab, an relevant notes/request by the primary guest, venue table host assigned to the table, waitress assigned to the table, security assigned to the section/table, concierge assigned to the table, and the like. The above is given as an example and should not be seen in a limiting manner. The system 10 may indicate which tables were booked by the venue directly and which tables were booked through the system 10. The above is given as an example and should not be seen in a limiting manner.

The system 10 may be configured to offer discounts to other who grow the popularity of the system 10. For example, promoters or others who refer customers to the system 10 may receive a 10% of their first table booking and 5% of their next 12 months bookings and 2.5% thereafter for the life of their account.

While the system 10 has been described as being used for VIP/bottle service, the system 10 may be used to provide other services. The system 10 may be used to provide private travel, restaurant/tasting menu and luxury travel. The above listing is given as an example and should not be seen in a limiting manner. As an example of using the system 10 for private travel, the system 10 may be used as a reservation system to book charter travel for individuals 16 similar to that described above.

The foregoing description is illustrative of particular embodiments of the invention, but is not meant to be a limitation upon the practice thereof. The following claims, including all equivalents thereof, are intended to define the scope of the invention.

What is claimed is:

1. A method for reserving a table for bottle service comprising:
connecting with a server hosting a reservation platform for table/bottle service reservations and communication;
displaying a list of venues having tables for table/bottle service reservations;
reserving a table at a venue on the list of venues by an individual through the reservation platform;
selecting a reservation type of the table through the reservation platform;
selecting a menu for the table selected;
sending a confirmation code for the table selected; and
scanning the confirmation code by the venue, the confirmation code showing guest name and the table reserved.

2. The method of claim 1, comprising displaying a layout of the venue showing table locations.

3. The method of claim 1, comprising displaying a plurality of reservation types, wherein the reservation types comprises an exclusive table booking where the individual books the whole table exclusively, a semi-exclusive table booking where the individual books and commits to paying for the entire table and reserve the right to accept or deny other request for the table, a reserved group table booking wherein the venue provides a minimum booking commitment prices per table, and an open group table booking wherein the venue provides a minimum booking commitment number.

4. The method of claim 1, comprising selecting a theme for the table selected.

5. The method of claim 1, comprising selecting optional services offered by the venue for the table selected.

6. The method of claim 1, wherein the optional services comprises: providing a photographer, providing security, providing a mixologist, and providing atmosphere models.

7. The method of claim 1, comprising sending out invites from the reservation platform to guest of the individual.

8. A computing device comprising:
a processor;
a display coupled to the processor;
a user interface coupled to the processor for entering data into the computing device; and
a memory coupled to the processor, the memory storing program instructions that when executed by the processor, causes the processor to:
connect with a server hosting a reservation platform for table/bottle service reservations and communication;
displaying a list of venues having tables for table/bottle service reservations;
reserving a table at a venue on the list of venues by an individual through the reservation platform;
selecting a reservation type of the table through the reservation platform;
selecting a menu for the table selected;
sending a confirmation code for the table selected; and
scanning the confirmation code by the venue, the confirmation code showing guest name and the table reserved.

9. The computing device of claim 8, wherein the memory storing program instructions that when executed by the processor, causes the processor to display a layout of the venue showing table locations.

10. The computing device of claim 8, wherein the memory storing program instructions that when executed by the processor, causes the processor to display a plurality of reservation types, wherein the reservation types comprises an exclusive table booking where the individual books the whole table exclusively, a semi-exclusive table booking where the individual books and commits to paying for the entire table and reserve the right to accept or deny other request for the table, a reserved group table booking wherein the venue provides a minimum booking commitment prices per table, and an open group table booking wherein the venue provides a minimum booking commitment number.

11. The computing device of claim 8, wherein the memory storing program instructions that when executed by the processor, causes the processor to display a plurality of table themes for the table selected, the individual selecting a desired table theme for the table selected.

12. The computing device of claim 8, wherein the memory storing program instructions that when executed by the processor, causes the processor to display optional services offered by the venue for the table selected, wherein the optional services comprises: providing a photographer, providing security, providing a mixologist, and providing atmosphere models.

13. The computing device of claim 8, wherein the memory storing program instructions that when executed by the processor, causes the processor to display themes for the table selected.

14. The computing device of claim 8, wherein the memory storing program instructions that when executed by the processor, causes the processor to send out invites from the reservation platform to guest of the individual.

15. The computing device of claim 8, wherein the memory storing program instructions that when executed by the processor, causes the processor to send out invites from the reservation platform to guest of the individual.

16. The computing device of claim 8, wherein the memory storing program instructions that when executed by the processor, causes the processor to display a communication menu allowing the individual to communicate with invited guest and staff at the venue.

17. The computing device of claim 8, wherein the memory storing program instructions that when executed by the processor, causes the processor to store photos to an account of the individual.

18. The computing device of claim 8, wherein the memory storing program instructions that when executed by the processor, causes the processor to display a review area allowing the individuals to rate and review the venue.

19. The computing device of claim 8, wherein the memory storing program instructions that when executed by the processor, causes the processor to calculate reward points for the individual, the reward points based on the monetary value spent by the individual in the venue.

20. The computing device of claim 8, wherein the memory storing program instructions that when executed by the processor, causes the processor to send notifications to the individuals of special events from participating venues.
